(19) United States
(12) Patent Application Publication
(10) Pub. No.: US 2025/0390613 A1
(43) Pub. Date: Dec. 25, 2025

(54) METHODS AND APPARATUS FOR VERIFICATION OF ON-CHIP SECURITY FEATURES FOR FIELD PROGRAMMABLE GATE ARRAYS

(71) Applicant: The United States of America, as Represented by the Secretary of the Navy, Crane, IN (US)

(72) Inventors: Christopher M. Sozio, Bloomington, IN (US); Zachary T. Jordan, Bloomington, IN (US)

(73) Assignee: The United States of America, as represented by the Secretary of the Navy, Arlington, VA (US)

(21) Appl. No.: 19/083,012

(22) Filed: Mar. 18, 2025

Related U.S. Application Data
(60) Provisional application No. 63/566,693, filed on Mar. 18, 2024.

(51) Int. Cl. G06F 21/76

(52) U.S. Cl. CPC G06F 21/76

(57) ABSTRACT

Disclosed are methods and apparatus that help determine security of a field programmable gate array (FPGA). The apparatus and methods facilitate communicating with an FPGA with predetermined instruction commands, and, in turn, generate a report based on the results of the predetermined commands, where the report is configured to provide information on the FPGA's security settings, as well as assist in determining and/or mitigating vulnerabilities.

### CROSS-REFERENCE TO RELATED APPLICATIONS

The present application claims priority to and the benefit of U.S. Provisional Patent Application Ser. No. 63/566,693 filed Mar. 18, 2024, and entitled “METHODS AND APPARATUS FOR VERIFICATION OF ON-CHIP SECURITY FEATURES FORFIELD PROGRAMMABLE GATE ARRAYS,” the entirety of which is expressly incorporated herein by reference.

### STATEMENT REGARDING FEDERALLY SPONSORED RESEARCH OR DEVELOPMENT

The invention described herein was made in the performance of official duties by employees of the Department of the Navy and may be manufactured, used and licensed by or for the United States Government for any governmental purpose without payment of any royalties thereon. This invention (Navy Case 212069US02) is assigned to the United States Government and is available for licensing for commercial purposes. Licensing and technical inquiries may be directed to the Technology Transfer Office, Naval Surface Warfare Center Crane, email: Crane_T2@navy.mil.

### FIELD

The present disclosure generally relates to assurance and security of field programmable gate arrays (FPGAs), and more particularly to apparatus and methods for verification of on-chip security features for field programmable gate arrays (FPGAs).

### BACKGROUND

Field-programmable gate array (FPGAs) are programmable integrated circuits that allow for configuration after construction of the circuits. In particular, FPGAs contain an array of programmable logic blocks, and reconfigurable interconnects allowing logic blocks to be wired together. Many FPGAs can be reprogrammed to implement different logic functions, allowing for flexible reconfigurable computing.

Operational characteristics of FPGAs are derived from a configuration file, known as a bitstream, which is typically applied during the boot-up process. Given the reprogrammability of FPGAs and their crucial applications in defense systems, for example, securing both the bitstream and the FPGA itself becomes important. Securing a modern FPGA, however, can be challenging due to the presence of multiple security setups, each requiring specific features for proper enablement. The complexity further increases as potential security vulnerabilities may be discovered, exposing setups to potential attacks.

Furthermore, known FPGA hardware design software may be compromised with tampering that could harbor malicious intent. Information pulled from the FPGA over a Joint Test Action Group (JTAG) interface by such software is typically collected by a vendor computer aided design (CAD) software. However, while this software offers transparency, it can potentially introduce a vulnerability if compromised, thereby opening the door to tampering. Accordingly, there is a need for further tools that can ensure that design software used for FPGA configurations remains untainted and that verify on-chip security features are properly configured and/or offer guidance on how to better mitigate security vulnerabilities for FPGAS.

### SUMMARY

The present disclosure includes methods and apparatus for providing a security mitigation(s) enforcer tool (SeME) (hereinafter the methods and apparatus referred to as synonymous with the SeME tool) that affords determination of whether or not an FPGA is secured properly and reporting of currently enabled security features of the FPGA. The disclosed SeME tool leverages the Joint Test Action Group (JTAG) to communicate with an FPGA through precise instruction commands. Through these commands, a report is generated that offers instructions on how to properly mitigate certain vulnerabilities. The disclosed SeME tool significantly reduces the time typically spent to search for documentation, equipping users with the beneficial materials to effectively and efficiently do the job of mitigating vulnerabilities.

Moreover, the disclosed SeME tool can serve as an educational tool, catering to novices unfamiliar with the internal FPGA security settings, as well as to professionals well-versed in FPGA technology. The presently disclosed tool not only underscores the significance of mitigating vulnerabilities, but also provides valuable insights to users on securing FPGAs effectively. Moreover, by consolidating the relevant information into one tool, SeME efficiently reduces the time spent looking up documentation.

In other aspects, the present disclosure provides an apparatus for determining security settings of a field programmable gate array (FPGA) including at least one processor, and an interface configured for communicatively coupling the at least one processor and an FPGA. Further, the at least one processor is configured to load the FPGA with predetermined instruction commands via the interface, monitor output results from the FPGA responsive to the predetermined instruction commands, analyze the output results from the FPGA to identify the status of one or more security settings of the FPGA, and generate an output report based on the output results, wherein the report includes information concerning the status of the one or more security setting of the FPGA.

In still other aspects, the present disclosure provides a method for determining security settings of a field programmable gate array (FPGA). The method includes loading the FPGA with predetermined instruction commands via an interface (e.g. a JTAG interface), monitoring output results from the FPGA responsive to the predetermined instruction commands, analyzing the output results from the FPGA to identify the status of one or more security settings of the FPGA, and generating an output report based on the output results, wherein the report includes information concerning the status of the one or more security setting of the FPGA.

Additional features and advantages of the presently disclosed invention will become apparent to those skilled in the art upon consideration of the following detailed description of the disclosed examples.

### BRIEF DESCRIPTION OF THE DRAWINGS

FIG. 1 illustrates an example of a graphical user interface (GUI) 100 of the disclosed apparatus showing detected devices, configuration registers and part properties on the left and the report and vulnerabilities/mitigations on the right according to some aspects of the present disclosure.

FIG. 2 illustrates a completed set of mitigations strategies for a particular attack (e.g., a Starbleed attack) vulnerability for an UltraScale/UltraScale+ part with optional security settings, important reminders and other helpful links according to some aspects of the present disclosure.

FIG. 3. illustrates an example of an interface of a BBRAM Key Programming window with DPA Protections enabled according to some aspects of the present disclosure.

FIG. 4 illustrates a system diagram of a presently disclosed apparatus for providing verification of on-chip security features for field programmable gate arrays (FPGAs) according to some aspects of the present disclosure.

FIG. 5 illustrates an exemplary flow diagram of a method for providing verification of on-chip security features for field programmable gate arrays (FPGAs) according to some aspects of the present disclosure.

### DETAILED DESCRIPTION

The disclosed examples of the present invention described herein are not intended to be exhaustive or to limit the present disclosure to the precise forms disclosed. Rather, the embodiments selected for description have been chosen to enable one skilled in the art to practice the invention.

As mentioned above, FPGA hardware design software may be compromised with tampering that could harbor malicious intent. Accordingly, one important aspect of the disclosed Security Mitigation(s) Enforcer (SeME) tool relates to circumventing the potential use of hardware design software that could harbor malicious intent. The disclosed SeME tools serves as a reliable intermediary, ensuring that the design software used in conjunction with FPGA configurations remains untainted. By deploying the disclosed SeME tool as a trusted bridge, users can confidently sidestep the risks associated with potential tampering, thus fortifying the security of FPGA related endeavors. Importantly, the disclosed SeME tool provides all of these features without requiring the installation of multiple Electronic Design Automation (EDA) tools. Rather, in some aspects the disclosed SeME tool serves as a one-stop shop, providing many assurance features in one centralized location.

In other aspects, a goal of the presently disclosed SeME tool is to provide for efficient triage for assessing device assurance for all FPGAs used within defense and/or commercial systems. The SeME tool features direct support for the majority of Xilinx and Intel architectures, as well as ongoing development for Microchip and Lattice as merely some examples. Additionally, the presently disclosed SeME tool offers an additional set of features for both Intel and Xilinx devices that are not traditionally offered by the official vendor EDA tools, enhancing the user experience and providing additional security measures for FPGAs. Further, the disclosed SeME tool aims to proactively secure FPGAs, and ensure that users remain ahead of potential threats before devices are deployed or utilized.

Moreover, presently disclosed apparatus and methods embody a tool that alleviates complexity and streamline the process for designers and system integrators, and are collectively referred to herein as a Security Mitigation(s) Enforcer (SeME) tool. This SeME tool serves as a valuable aid in navigating the intricate landscape of FPGA security, assists users in determining currently enabled on-chip security features, and provides guidance on which security features need activation to safeguard against specific vulnerabilities or potential attacks. The presently disclosed SeME tool also provides a supplementary set of features that enhance overall device assurance and user experience.

Furthermore, the presently disclosed SeME tool may be configured to generate a detailed report of all enabled security features and provide guidance to users on how to properly mitigate open-sourced vulnerabilities based on the information from the report. The tool supports multiple FPGA vendors, including Xilinx and Intel. Additionally, the tool allows for efficient comparison of multiple devices simultaneously. Some additional features SeME provides is a Read back Configuration, programming of the battery-backed RAM (BBRAM) Key with Differential Power Analysis (DPA) protections, and determining properties of over 2,000 unique parts.

Moreover, the disclosed SeME tool provides verification of on-chip security settings, information on configuration registers, and other helpful device data for FPGAs. The SeME tool may assure that the target FPGA meets the Levels of Assurance (LoA) guidance and best practices to mitigate any threats that could affect the device. A report is generated to identify the information that SeME was able to access from on-chip settings and registers and will determine if they properly setup to mitigate specific threats. SeME can be used to provision the FPGA with key material and can read back FPGA configuration if the device is able and allows it. All of the capabilities and information of SeME is included in an easy to use graphical user interface to offer easy access for all users.

It is noted that without the presently disclosed SeME tool, security teams must manually search for the appropriate security materials to counter vulnerabilities, with the added challenge of new threats emerging. The presently disclosed SeME tool streamlines the process, requiring only a single user to navigate the SeME tool, as it is mainly autonomous and provides the user with up front information on known vulnerabilities. Moreover, the SeME tool continuously updates with the latest mitigations for newly discovered vulnerabilities, offering users a strategic advantage in ensuring FPGA assurance.

As mentioned above, the SeME tool generates a comprehensive report encompassing all data acquired via the Joint Test Action Group (JTAG) interface. This report provides a valuable resource by furnishing a user with vital information such as an FPGA's IDCODE and device specific registers such as Xilinx's DNA, which are important components for validating the authenticity of the FPGA. Additionally, the SeME tool provides access to architecture-specific security registers, which includes essential details like the RSA public key.

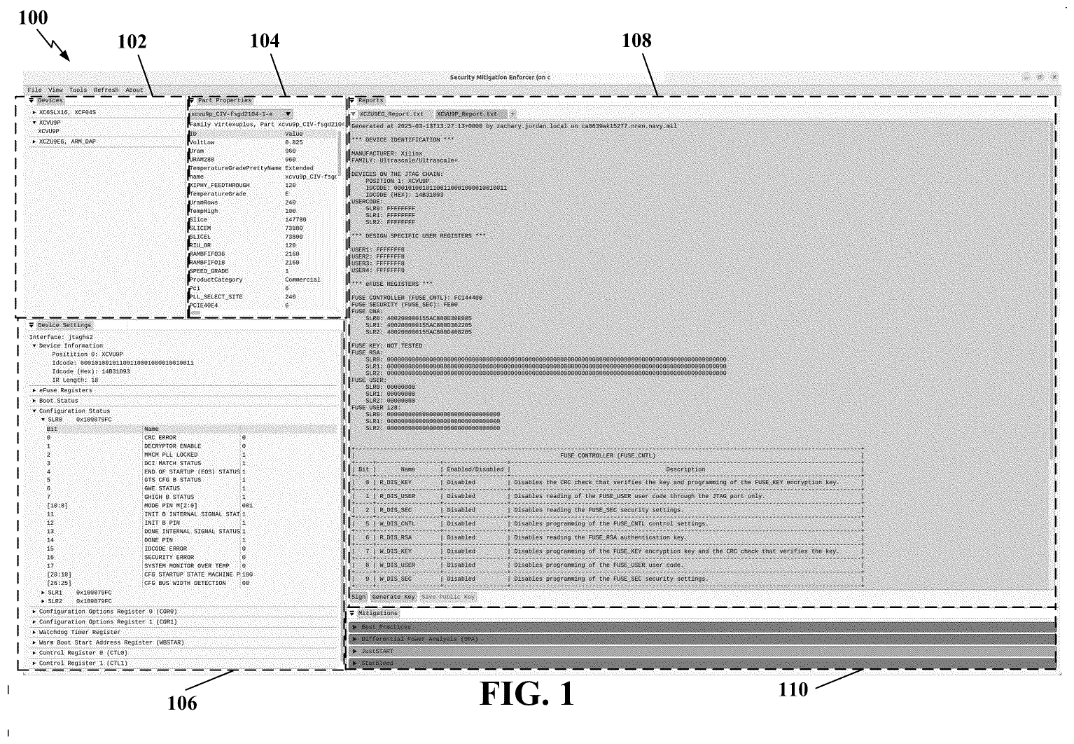

The information is then integrated into a graphical user interface (GUI) 100 as illustrated in FIG. 1, which is displayed to a user by the presently disclosed SeME tool. This GUI 100 serves as an analytical tool, dissecting the FPGA-derived data and cross-referencing the data against predetermined, known, or commonly applied mitigations for specific attack scenarios. In instances where a particular mitigation has not been implemented, the GUI or interface 100 provides and instructive resource interface offering clear guidance to a user on steps or actions that are required to enact a mitigation strategy. This approach ensures that users are empowered to effectively harden their FPGA's security while maintaining a deep understanding of the safeguarding measures in place.

As may be seen in FIG. 1, the interface 100 includes display of particular FPGA devices coupled to the tool (or a host machine) as shown at box 102. Additionally the interface may display part properties of a targeted FPGA device as shown in box 104. Further, the interface 100 may display target FPGA device information and configuration registers as shown in box 106. Additional information is shown in box 106 including a breakdown of the configuration settings and the representation of each bit. In another part of the interface 100, a generated report may be displayed that includes a report of at least one of the selected FPGA device with the device's current enabled security settings as shown at box 108. Finally, the interface 100 may be configured to display mitigation information including a list of vulnerabilities as shown at box 110, and further each entry in the list having a drop down of mitigations that may be enabled including clear guidance information displayable to a user on steps or actions that are required to enact a mitigation strategy

According to one example, the presently disclosed SeME tool can provide a mitigation strategy for countering malicious attacks such as a Starbleed attack (See last entry in box 110 as an example) on an UltraScale/UltraScale+ FPGA. One approach involves the enforcement of only RSA authenticated bitstreams, which is a measure that is dependent upon the correct configuration of the eFUSE register that requires all bitstreams to be authenticated through RSA. In scenarios where this configuration is incomplete, the SeME tool actively alerts the user and delivers clear instructions for successfully programming the RSA key and cFUSE register.

According to other aspects, the presently disclosed tool helps with mitigating the circumventing of the potential use of hardware design software that could harbor malicious intent. The information pulled from a FPGA over a JTAG interface is collected by the vendor computer aided design (CAD) software in one example, but not limited to such software. However, while this software offers transparency, it could introduce a vulnerability if compromised, opening the door to tampering. This underlines the advantages of the presently disclosed SeME tool as a reliable intermediary that ensures that the design software used in conjunction with FPGA configurations remains untainted. By deploying the SeME tool as a trusted bridge, users can confidently sidestep the risks associated with potential tampering, thus fortifying the security of their FPGA related endeavors. The presently disclosed SeME tool provides all of these features without requiring the installation of multiple Electronic Design Automation (EDA) tools. Rather, the SeME tool serves as a lightweight one-stop shop, providing many assurance features in one centralized location.

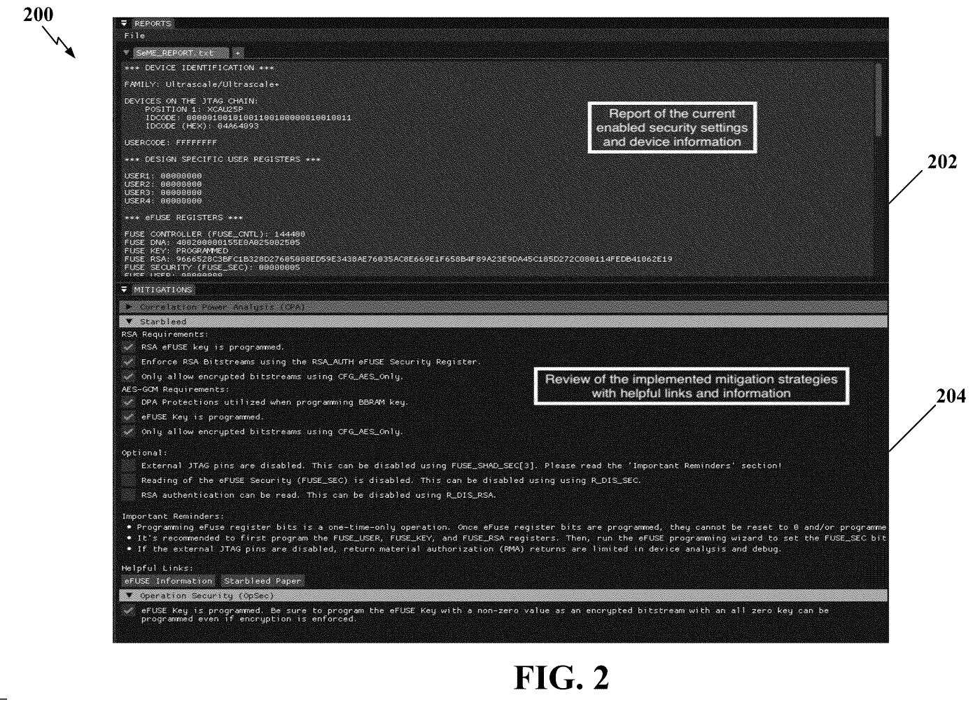

Furthermore, as mentioned above the disclosed SeME tool is configured to provide mitigation guidance to properly secure a device integrated within each vendor's official documentation, thereby providing a comprehensive and reliable reference. Moreover, the SeME tool performs an additional extra step that provides a user with knowledge of device security and safety. In the process of programming security registers, the software provides informative insights and warnings. Notably, users are cautioned that when security (FUSE-based) registers are classified as one-time programmable (OTP), underlining the irreversible nature of their programming. An example of this information, along with the list of mitigations for the Starbleed vulnerability is shown in the example GUI screen 200 illustrated in FIG. 2. In particular, FIG. 2 illustrates the report of the current enabled security settings and the FPGA device information as shown at 202. Additionally, the report in screen or display of interface 200 shows a completed set of mitigations strategies at 204 for a particular attack (e.g., a Starbleed attack) vulnerability for an UltraScale/UltraScale+ part with optional security settings, important reminders and other helpful links according to some aspects of the present disclosure.

Beyond equipping users with the essential information for securing their devices, the presently disclosed SeME tool also provides additional capabilities to enhance overall device assurance and user experience. As an example, it is noted that the SeME tool supports various FPGA families from both Xilinx and Intel, as examples, and comprised of a wide range of distinct parts. Specifically in one example, there are over 167 unique Xilinx FPGA parts supported with the ability to interact with multiple parts at once. There are also a variety of ways to interact with these FPGAs using various cables and interfaces. To address this, SeME integrates support for multiple cables such as JTAG-HS1 and Xilinx Platform Cable (XPC) for seamless connection to Xilinx devices. In the case of Intel devices, USBBlaster may be utilized for connection and JTAG communication, as one example,

As may be appreciated by those skilled in art, the presently disclosed SeME tool may support a number of different FPGA devices and/or communication tools. As merely one example, Table 1 below shows an exemplary list of devices and communication tools that the presently disclosed SeME tool supports.

TABLE 1

| VENDOR | FAMILY |
|---|---|
| Xilinx | Spartan 6* |
| Xilinx | Virtex 6 |
| Xilinx | Spartan 7 |
| Xilinx | Artix 7* |
| Xilinx | Kintex 7* |
| Xilinx | Virtex 7 |
| Xilinx | Zynq 7* |
| Xilinx | Kintex US/US+* |
| Xilinx | Virtex US/US+* |
| Xilinx | Zynq US* |
| Intel | MAX II |
| Intel | MAX 10* |
| Intel | Cyclone IV* |
| Intel | Cyclone 10 GX* |
| Intel | Cyclone 10 LP* |

COMMUNICATION

FTDI USB
Xilinx Platform Cable (XPC)
JTAG-HS1
JTAG-HS2
USB-Blaster I
*Denotes first class device support for tested devices

The presently disclosed SeME tool also provides enhanced guidance in deploying security measures, particularly against the threat of Differential Power Analysis (DPA). DPA is a sophisticated side-channel attack technique that exploits power consumption patterns to deduce sensitive information from electronic devices, such as cryptographic keys. To counteract the vulnerabilities associated with DPA, SeME offers a few specialized features. For example, in Xilinx devices, SeME allows users to program a Battery Backed RAM (BBRAM) symmetric key with dedicated DPA safeguards. This can be done in the field without multiple gigabytes of EDA tools.

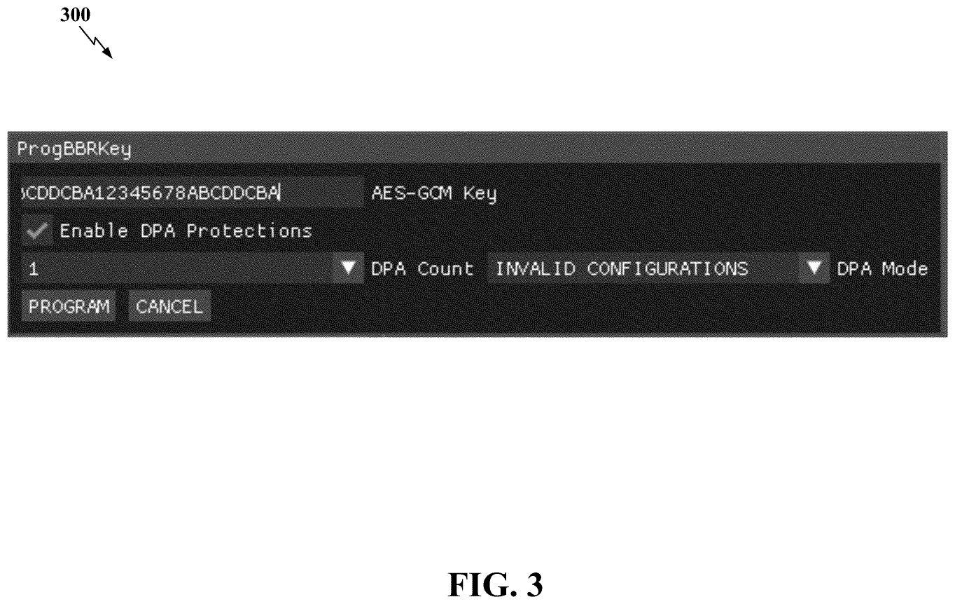

Users utilizing SeME gain the flexibility to customize DPA protection parameters based on their specific configuration requirements. This includes the ability to set the DPA Count up to 255 and choose the DPA Mode (Invalid or All Configurations) shown in the interface 300 displayed in FIG. 3. This level of customization empowers users to align their security measures with the unique demands of their FPGA configurations.

In still further aspects, the disclosed SeME tool also provides security registers. There are JTAG instructions registers specific to the security settings on each FPGA that can be utilized to retrieve important device security information. For example, in Intel FPGAs there is a Key Verify instruction that allows users to read out the information associated with the volatile and non-volatile key features that are currently enabled on the FPGA chip. Similarly, Xilinx offers an eFUSE Security (FUSE SEC) instruction, providing users with information such as if their device is restricted to only allow encrypted bitstreams or if the external JTAG pins are disabled. These security features play an important role in providing users with feedback on potential mitigations they can implement on their devices.

Of further note, FPGA devices are equipped with distinct registers, including crucial ones like the Boot Status or Configuration Status register, which provide users with essential insights into the FPGA device. These registers are configuration specific. For instance, a Control Register 0 (CTL 0) has the capability of indicating the key source in the configuration file, whether it is pulled from BBRAM or the eFUSE. These registers offer valuable insights into the configuration file, thereby ensuring that the correct register bits are set and there are no errors.

As previously mentioned, in the case of Xilinx, for example, the SeME tool extends support to over 167 unique parts. This includes variations with different IO counts and speed grades, all consolidated under the main part name (e.g., XCKU5P-Kintex UltraScale+). Each part is associated with properties such as Look-Up Table (LUT) counts or the quantity of Super Logic Regions (SLR) within a single FPGA. With this information, users receive a quick and comprehensive understanding of the specific part they are working on, thereby eliminating the need to navigate through CAD tools to search for this information.

Inspecting the integrity of security features is crucial both pre and post FPGA deployment. The SeME tool also enables the ability to program configuration files to FPGAS, allowing for subsequent checks using the configuration registers detailed herein. Once it is confirmed that there are no errors with the bitstream, users can proceed to read back the configuration. This read back process provides verification of the device, ensuring that the configuration data programmed to the FPGA aligns with the intended bitstream. SeME allows rapid verification of FPGA content and settings in the field with no additional dependency overhead.

SeME is continuously being updated with new devices, including Versal and features supporting System on Chip (SoC) FPGAs. Currently, Xilinx and Intel FPGAs are in focus with a plan to implement other architectures such as Microchip and Lattice. As new vulnerabilities arise, SeME may be updated with new mitigation strategies that provide users with the necessary information to stay ahead of adversaries. Any relevant information may be provided by SeME for users to deploy mitigations to their FPGAs quickly.

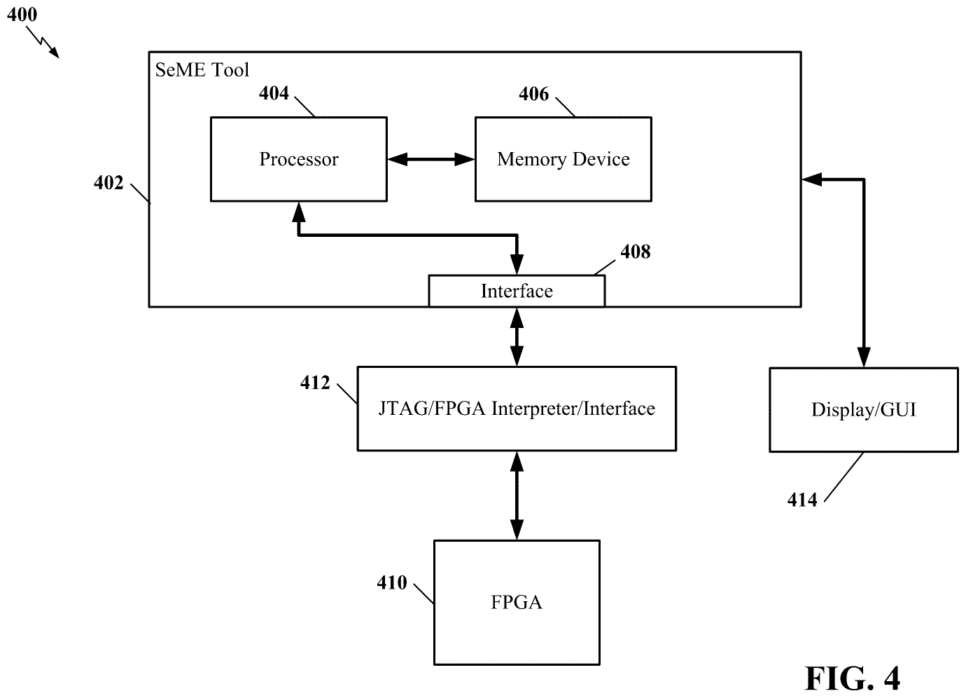

FIG. 4 illustrates a system diagram 400 of a presently disclosed apparatus for providing verification or information of on-chip security settings and/or features for field programmable gate arrays (FPGAs) according to some aspects of the present disclosure.

As illustrated, the system 400 includes a SeME tool 402, which is configured to effectuate the various features as discussed above. The tool 402 may include at least one processor 404 for implementing the various processes for determining security settings of an FPGA, as well as providing or determining security mitigation recommendations and procedures or guidance. The SeME tool 400 may further include a memory device 406 coupled to the at least one processor 404. Additionally the SeME tool 404 includes an interface 408 configured for communicatively coupling the at least one processor 404 and at least one FPGA 410. It is noted that in some aspects, the apparatus 400 may include a separate JTAG/FPGA interpreter or interface 412 for interpreting JTAG commands to and from the FPGA 410. In further embodiments the interface 412 may be incorporated within the SeME tool 402, such as within interface 408. For purposes of the present disclosure, those skilled in the art will recognize that interface 408 and interface 412 may collectively be considered an “interface” that communicatively couples the at least one processor 404 and at least one FPGA 410.

According to yet further aspects, the SeME tool 402 may be communicatively coupled to a display device or GUI 414, such as a display implemented by a computer or tablet, but not limited to such display/GUI enabling devices. Examples of information displayed by the SeME tool 402 may be seen in FIGS. 1-3 discussed above.

In some aspects, the interface(s) 408, 412 provide an infrastructure for the tool 402 to communicate with the FPGAs through JTAG including interpreting what is received from the FPGA 410. The data received enable the tool 402 and processor 404, in particular, to the be able to determine if certain mitigations are properly enabled or something is missing and be able to provide that feedback to the user via the display/GUI 414. Additionally, it is noted that the memory device 406, as one example, may be updated on the latest FPGA vulnerabilities or attacks to ensure guidance is updated for SeME tool 402.

According to yet further aspects, the processor 404 may be responsible for managing general processing, including the execution of software stored on memory device 406, which may be also referred to as a computer-readable medium. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software, when executed by the processor 404, causes tool 402 to perform the various functions described above for any particular apparatus and/or FPGA. The memory device or computer-readable medium 406 may also be used for storing data that is manipulated by the processor 404 when executing software.

In yet further aspects, the memory device or computer-readable medium 406 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an crasable PROM (EPROM), an electrically erasable PROM (EEPROM), a register, a removable disk, and any other suitable medium for storing software and/or instructions that may be accessed and read by a computer. The computer-readable medium 406 may reside in the SeME tool 402, external to the SeME tool 402, or distributed across multiple entities including the SeME tool 402. The computer-readable medium 406 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In operation, the SeME tool 402 and/or processor 404 may be configured to load the FPGA 410 with predetermined instruction commands via the interface (e.g., 408 and/or 412). Next, the tool 402 is configured to monitor output results from the FPGA responsive to the predetermined instruction commands. Moreover, the SeME tool 402 and/or processor 404 is configured to analyze the output results from the FPGA 410 to identify the status of one or more security settings of the FPGA 410. Finally, the SeME tool 402 and/or processor 404 are configured to generate an output report based on the output results of the predetermined commands (Sec e.g., FIGS. 1 and 2), wherein the report includes information concerning the status of the one or more security setting of the FPGA 410.

In yet further aspects the at least one processor 404 and/or tool 402 is further configured to analyze the output results from the FPGA and cross-reference the output results against predetermined mitigations for one or more specific attack scenarios, such as can be seen in FIGS. 1 and 2, for example.

As discussed before, the at least one processor 404 and/or tool 402 is further configured to implement a graphical user interface GUI on a display device (e.g., 414), as was also discussed in connection with FIGS. 1 and 2, for example.

In still further aspect, the at least one processor 404 and/or too 402 is further configured to analyze the output results from the FPGA and cross-reference the output results against predetermined mitigations for one or more scenarios (See e.g., this process may result in boxes 108, 110, and/or 204 as discussed above. This may include displaying instructions or guidance concerning steps for enacting a mitigation strategy for each of the predetermined mitigations. Furthermore, the at least one processor 404 and/or tool 402 is further configured to display information concerning FUSE-based security registers that are classified as one time programmable (OTP) for communicating an irreversible nature of the FPGA programming, examples of which may be seen in box 108 as an example.

In still further aspects, the at least one processor 404 and/or tool 402 is configured to send configuration files for programming the FPGA 410 to allow for subsequent checks using configuration registers to enable confirmation of no errors within a bitstream from the FPGA to verify the FPGA.

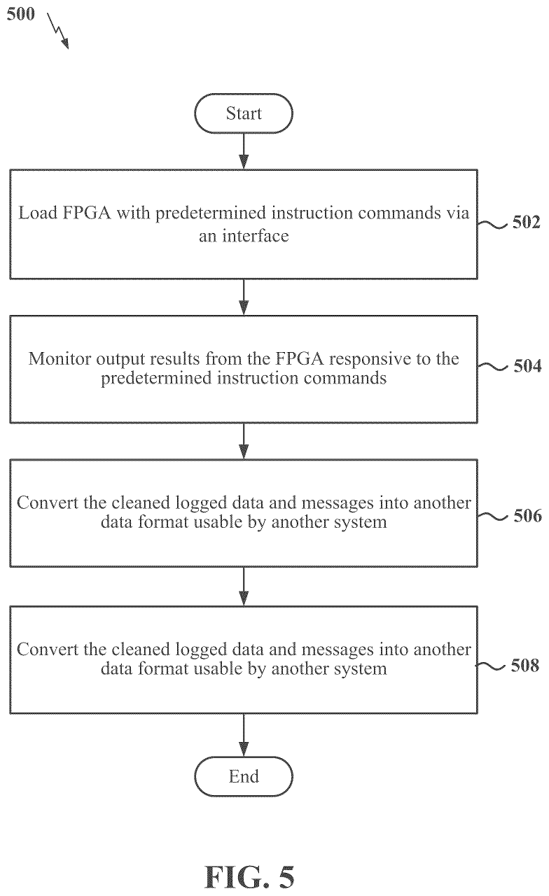

FIG. 5 illustrates an exemplary flow diagram of a method 500 for providing verification of on-chip security features for field programmable gate arrays (FPGAs) according to some aspects of the present disclosure. As shown, the method 500 includes loading an FPGA (e.g., 410) with predetermined instruction commands via an interface (e.g., 408 and/or 412) as shown at block 502. Method 500 further includes monitoring output results from the FPGA responsive to the predetermined instruction commands as shown at block 504. Additionally, method 500 includes analyzing the output results from the FPGA to identify the status of one or more security settings of the FPGA as shown at block 506. Finally, method 500 includes generating an output report based on the output results, wherein the report includes information concerning the status of the one or more security setting of the FPGA as shown at block 508.

In conclusion, results gathered by SeME can be captured within a detailed report respective to specific FPGA devices and architectures, including identified vulnerabilities and the mitigation strategies to address those vulnerabilities.

Of further note, commercial applications may ensure key and security provisioning was completed correctly, allowing companies to ensure their FGPA devices/products are secure.

Although the invention has been described in detail with reference to certain preferred embodiments, variations and modifications exist within the spirit and scope of the invention as described and defined in the following claims.

What is claimed is:

1. An apparatus for determining security settings of a field programmable gate array (FPGA) comprising:
at least one processor; and
an interface configured for communicatively coupling the at least one processor and an FPGA;
wherein the at least one processor is configured to:
load the FPGA with predetermined instruction commands via the interface;
monitor output results from the FPGA responsive to the predetermined instruction commands;
analyze the output results from the FPGA to identify the status of one or more security settings of the FPGA; and
generate an output report based on the output results, wherein the report includes information concerning the status of the one or more security setting of the FPGA.

2. The apparatus of claim 1, wherein the at least one processor is further configured to:
analyze the output results from the FPGA and cross-reference the output results against predetermined mitigations for one or more specific attack scenarios.

3. The apparatus of claim 1, wherein the at least one processor is further configured to implement a graphical user interface GUI on a display device.

4. The apparatus of claim 3, wherein the at least one processor is further configured to:
analyze the output results from the FPGA and cross-reference the output results against predetermined mitigations for one or more scenarios; and
display instructions or guidance concerning steps for enacting a mitigation strategy for each of the predetermined mitigations.

5. The apparatus of claim 3, wherein the at least one processor is further configured to:
display information concerning FUSE-based security registers that are classified as one time programmable (OTP) for communicating an irreversible nature of the FPGA programming.

6. The apparatus of claim 1, wherein the at least one processor is further configured to:
send configuration files for programming the FPGA to allow for subsequent checks using configuration registers to enable confirmation of no errors within a bitstream from the FPGA to verify the FPGA.

7. The apparatus of claim 1, wherein the at least one processor is further configured to:
receive user inputs for a Battery Backed RAM (BBRAM) symmetric key with dedicated differential power analysis (DPA) safeguards.

8. The apparatus of claim 1, wherein the at least one processor is further configured to:
receive user customization of one or more DPA protection parameters.

9. The apparatus of claim 1, wherein the interface comprises a Joint Test Action Group (JTAG) interface for interpreting JTAG commands from the FPGA.

10. A method for determining security of a field programmable gate array (FPGA) comprising:
loading the FPGA with predetermined instruction commands via an interface;
monitoring output results from the FPGA responsive to the predetermined instruction commands;
analyzing the output results from the FPGA to identify the status of one or more security settings of the FPGA; and
generating an output report based on the output results, wherein the report includes information concerning the status of the one or more security setting of the FPGA.

11. The method of claim 10, further comprising:
analyzing the output results from the FPGA and cross-reference the output results against predetermined mitigations for one or more specific attack scenarios.

12. The method of claim 10, further comprising implementing a graphical user interface GUI on a display device.

13. The method of claim 12, further comprising:
analyzing the output results from the FPGA and cross-reference the output results against predetermined mitigations for one or more scenarios; and
displaying instructions or guidance concerning steps for enacting a mitigation strategy for each of the predetermined mitigations.

14. The method of claim 12, further comprising displaying information concerning FUSE-based security registers that are classified as one time programmable (OTP) for communicating an irreversible nature of the FPGA programming.

15. The method of claim 10, further comprising:
sending configuration files for programming the FPGA to allow for subsequent checks using configuration registers to enable confirmation of no errors within a bitstream from the FPGA to verify the FPGA.

16. The method of claim 10, further comprising:
receiving user inputs for a Battery Backed RAM (BBRAM) symmetric key with dedicated differential power analysis (DPA) safeguards.

17. The method of claim 10, further comprising:
receiving user customization of one or more DPA protection parameters.

18. The method of claim 10, wherein the interface comprises a Joint Test Action Group (JTAG) interface for interpreting JTAG commands from the FPGA.
